(19) United States
(12) Patent Application Publication
(10) Pub. No.: US 2023/0339821 A1
(43) Pub. Date: Oct. 26, 2023

(54) SI-BASED COMPOSITE BOND COAT CONTAINING CRISTOBALITE MODIFIER FOR ENVIRONMENTAL BARRIER COATINGS

(71) Applicant: OERLIKON METCO (US) INC., Westbury, NY (US)

(72) Inventor: Dianying CHEN, Westbury, NY (US)

(73) Assignee: OERLIKON METCO (US) INC., Westbury, NY (US)

(21) Appl. No.: 18/022,585

(22) PCT Filed: Nov. 5, 2021
(86) PCT No.: PCT/US2021/058287

§ 371 Date: Feb. 22, 2023

Related U.S. Application Data
(60) Provisional application No. 63/186,400, filed on May 10, 2021.
(60) Provisional application No. 63/111,887, filed on Nov. 10, 2020.

(51) Int. Cl. C04B 41/50; C04B 41/45; C04B 41/87

(52) U.S. Cl. CPC C04B 41/5096; C04B 41/4531; C04B 41/4533; C04B 41/5045; C04B 41/5032; C04B 41/87; C04B 2235/3208; C04B 2235/428; C04B 2235/3222; C04B 2235/3213; C04B 2235/3215; C04B 2235/3224

(57) ABSTRACT

A Si-based composite bond coat for environmental barrier coatings on a Si-based ceramic matrix composite that protects the CMC from an oxidation environment by in-situ modifying a thermally grown oxide (TGO) using a TGO modifier to suppress cristobalite TGO cracking during thermal cycling in a gas turbine engine.

This application claims priority to U.S. Provisional Application No. 63/111,887, filed Nov. 10, 2020 and U.S. Provisional Application No. 63/186,400 filed May 10, 2021. The disclosure of each of these applications is herein incorporated by reference in its entirety.

### BACKGROUND OF THE INVENTION

### 1. Field of the Disclosure

Example embodiments relate to a bond coat for environmental barrier coatings (EBCs) on Si-based ceramic matrix composites (CMCs) that can protect the CMCs in a high temperature oxidation environment. In particular, example embodiments relate to a silicon-based composite bond coat containing a thermally grown oxide (TGO) modifier that suppresses TGO phase transformation and cracking during thermal cycling in a gas turbine engine.

### 2. Background Information

Environmental barrier coatings (EBCs) have been applied onto Si-based ceramic matrix composites for the protection of CMCs from oxidation and water vapor attack. Current EBC structures consist of a Si bond coat and protective top layers such as rare earth silicates with the general formulas RE₂SiO₅ (mono-silicates) and RE₂Si₂O₇ (di-silicates). When exposed to a high temperature oxidation environment in gas turbine engines, the Si bond coat will be oxidized to form a thermally grown oxide (TGO) SiO₂ layer. At high temperatures, the silica TGO phase undergoes a first order, displacive transformation from a stable cubic β-cristobalite structure to a tetragonal α-cristobalite upon cooling to ˜220° C. The transformation from β-to-α is accompanied by a ˜4.9% volume reduction which causes microcracking in the TGO layer. During continuous cycling, the TGO microcracks provide a fast diffusion path for oxidants, such as oxygen and water vapor, that reach the Si bond coat surface and accelerate its oxidation rate. Repeating thermal cycling results in the rapid growth and severe cracking behavior of the TGO layer. The rapid growth of the TGO layer induces an interfacial volume increase between the topcoat and the bond coat that generates out of plane tensile stresses on the EBCs system. When the tensile stress exceeds the bonding strength of the coatings, spallation will occur. Thus, new EBCs having a bond coat that can prevent the thermally grown SiO₂ oxide phase transformation as well as the resultant cracking behavior are needed for a highly durable EBCs system.

### SUMMARY

EBCs can be deposited onto Si-based CMC substrates for the protection of the CMC from oxidation and water vapor attack. In a high temperature gas turbine engine environment, the Si bond coat is oxidized to form a TGO SiO₂ layer. Upon cooling, the SiO₂ TGO undergoes a first order, displacive transformation from β-to-α cristobalite, upon cooling to ˜220° C. The transformation from β-to-α is accompanied by a ˜4.9% volume reduction which causes microcracking in the TGO layer. The microcracks result in loss of oxidation protection, rapid TGO growth, and spallation of the EBCs.

The Si-oxide composite bond coat for EBCs on a CMC substrate of the present disclosure protects the CMC from oxidation by in-situ modifying a TGO layer using a TGO modifier to suppress cristobalite TGO cracking during thermal cycling in a gas turbine engine. Accordingly, the Si-oxide composite bond coat of the present disclosure can significantly improve the component life, e.g., an engine component life, of CMCs, and therefore improves the engine life, in a high temperature oxidation environment.

“TGO modifier” is defined as a rare earth aluminate, an oxide, including a rare earth oxide, Al₂O₃, mullite, an alkali metal oxide, an alkaline earth oxide, an alkaline earth silicate, a spinel phase AB₂O₄ (in which “A” represents at least one of Mg, Ca, Ba, Sr, or Zn, and “B” represents at least one of Al, Fe, Cr, Co, or V), and mixtures thereof.

Example embodiments of the present disclosure relate to a bond coat on a Si-based CMC and a composite powder manufacturing method. In example embodiments, the bond coat composite is composed of Si and at least one oxide including at least one rare earth oxide, Al₂O₃, Mullite, an alkali metal oxide, an alkaline earth oxide, an alkaline earth silicate, a spinel phase AB₂O₄ (“A” represents at least one of Mg, Ca, Ba, Sr, or Zn, and “B” represents at least one of Al, Fe, Cr, Co, or V), and combinations thereof. In example embodiments, the concentration of Si in the bond coat composite is in the range of 50 mol % to 99.9 mol %.

For mixed oxides in Si-based composites, it is preferable to mix at least one oxide with two valence cations and at least one oxide with three valence cations. In example embodiments, it is preferable to select CaO—Al₂O₃, SrO—Al₂O₃, and BaO—Al₂O₃ mixtures. In example embodiments, the Si-based composite is a Si—CaO—Al₂O₃ composite in which the ratio of CaO/Al₂O₃ is in the range of 0.1-1 and the concentration of the mixed oxides in the Si—CaO—Al₂O₃ composite is in the range of 1-10 mol %. In another example embodiments, the Si-based composite is a Si—SrO—Al₂O₃ composite in which the ratio of SrO/Al₂O₃ is in the range of 0.1-1 and the concentration of the mixed oxides in the Si—SrO—Al₂O₃ composite is in the range of 1-10 mol %. In another example embodiments, the Si-based composite is a Si—BaO—Al₂O₃ composite in which the ratio of BaO/Al₂O₃ is in the range of 0.1-1 and the concentration of the mixed oxides in the Si—BaO—Al₂O₃ composite is in the range of 1-10 mol %.

The oxide concentration in the Si-based composite is in a range of 0.01 mol % to 50 mol %. Preferably, the oxide concentration is in a range of 0.1 mol % to 20 mol %. More preferably, the oxide concentration is in a range of 1 mol % to 10 mol %. Preferably, there is no boron included in the Si-oxide composite bond coat. During TGO growth at high temperatures, the cations of the oxides in the Si based bond coat will diffuse and incorporate into the β-cristobalite SiO₂ TGO structure, which stabilizes the β-cristobalite phase and prevents its phase transformation during cooling. Therefore, TGO cracking behavior will not occur.

In embodiments, the oxide is an alkaline earth oxide including BeO, MgO, CaO, SrO, BaO, RaO, and combinations thereof. In other embodiments, the oxide is an alkaline earth silicate including CaO, MgO and SiO₂. In embodiments, the oxide is an alkali metal oxide including Li₂O, Na₂O, K₂O, Rb₂O, and Cs₂O. In other embodiments, the oxide is an alkali metal suboxide including Rb₆O, Rb₉O₂, CsO, Cs₃O, Cs₄O, Cs₇O, Cs₃O₂, Cs₇O₂, Cs₁₁O₃, Cs₁₁RbO₃, Cs₁₁Rb₂O₃, Cs₁₁Rb₃O₃. In embodiments, the oxide is an alkali metal peroxide including Li₂O₂, Na₂O₂, K₂O₂, Rb₂O₂, and Cs₂O₂. In example embodiments, the oxide is an alkali metal superoxide including LiO₂, NaO₂, KO₂, RbO₂, and CsO₂. In other embodiments, the oxide is an alkali metal ozonide including LiO₃, NaO₃, KO₃, RbO₃, and CsO₃.

In preferred embodiments, the oxide is at least one rare earth oxide including Y, La, Ce, Pr, Nd, Pm, Sm, Eu, G, Tb, Dy, Ho, Er, Tm, Yb, Lu, and combinations thereof.

In another example, the bond coat composite is composed of Si and at least one rare earth aluminate including RE₃Al₅O₁₂, REAlO₃, RE₄Al₂O₉, and combinations thereof, in which RE represents at least one rare earth oxide including Y, La, Ce, Pr, Nd, Pm, Sm, Eu, G, Tb, Dy, Ho, Er, Tm, Yb, Lu, and combinations thereof.

To prepare the Si-based composite, it is preferable to mix at least one rare earth aluminate and the at least one rare earth oxide in the Si-based composite. In example embodiments, it is preferable to select Y₂O₃—Y₃Al₅O₁₂ mixtures or Yb₂O₃—Yb₃Al₅O₁₂. The concentration of the mixed oxides in the Si composite is in a range of 0.01 mol % to 50 mol %, preferably in a range of 0.1 mol % to 20 mol %, and more preferably in a range of 1 mol % to 10 mol %.

In example embodiments, the rare earth oxide concentration in the Si-based composite is in a range of 0.01 mol % to 50 mol %. Preferably, the rare earth oxide concentration is in a range of 0.1 mol % to 20 mol %. More preferably, the rare earth oxide concentration is in a range of 1 mol % to 10 mol %. Preferably, there is no boron included in the Si-oxide composite bond coat. During TGO growth at high temperatures, the cations of the rare earth oxides in the Si-based bond coat will diffuse and incorporate into the β-cristobalite SiO₂ TGO structure, which stabilizes the β-cristobalite phase and prevents its phase transformation during cooling. Therefore, TGO cracking behavior will not occur.

In example embodiments, the rare earth aluminate in the Si-based composite is in a range of 0.01 mol % to 50 mol %. Preferably, the rare earth aluminate concentration is in a range of 0.1 mol % to 20 mol %. More preferably, the rare earth aluminate concentration is in a range of 1 mol % to 10 mol %. Preferably, there is no boron included in the Si-oxide composite bond coat. During TGO growth at high temperatures, the cations of the rare earth aluminate in the Si-based bond coat will diffuse and incorporate into the β-cristobalite SiO₂ TGO structure, which stabilizes the β-cristobalite phase and prevents its phase transformation during cooling. Therefore, TGO cracking behavior will not occur.

The Si-oxide composite bond coat of the present disclosure can suppress the cubic to tetragonal cristobalite phase transformation of the TGO layer during cooling. Additionally, the Si-oxide composite bond coat can suppress the TGO layer from cracking in a high temperature oxidation environment. Accordingly, the Si-oxide composite bond coat can significantly improve the component life, e.g., an engine component life, of CMCs, and therefore improves the engine life, in a high temperature oxidation environment.

### BRIEF DESCRIPTION OF THE DRAWINGS

The present disclosure is further described in the detailed description which follows, in reference to the noted plurality of drawings, by way of non-limiting examples of preferred embodiments of the present disclosure.

FIG. 1 illustrates a multilayer coating structure having a Si-based composite bond coat, according to various embodiments.

FIG. 2 illustrates a scanning electron microscope (SEM) image of an EBC microstructure after a steam test using a conventional Si bond coat, according to the prior art.

FIG. 3 illustrates a scanning electron microscope (SEM) image of an EBC microstructure after a steam test using a Si-oxide composite bond coat, according to various example embodiments.

### DETAILED DESCRIPTION

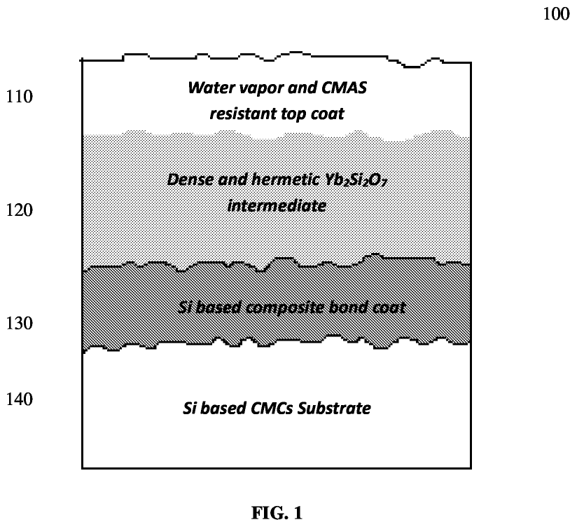

FIG. 1 illustrates a multilayer coating structure 100 having a Si-based composite bond coat 130, according to various embodiments. In FIG. 1, the multilayer coating structure 100 includes a Si-based composite bond coat 130 on the Si-based CMC substrate 140, a dense and hermetic Yb₂Si₂O₇ intermediate layer 120 deposited on the Si-based composite bond coat 130, and a calcium-magnesium-aluminosilicate (CMAS) resistant topcoat 110 deposited on the dense and hermetic Yb₂Si₂O₇ intermediate layer 120.

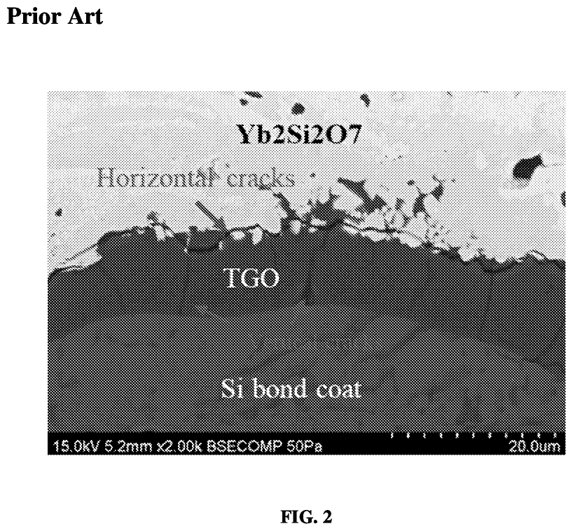

FIG. 2 illustrates a SEM image of an EBC microstructure having a Yb₂Si₂O₇ protective top layer, a Si bond coat, and a TGO layer, according to the prior art. In FIG. 2, the EBC microstructure shows a vertical crack in the TGO layer and horizontal cracks between the interface of the topcoat layer and the TGO layer after conducting a steam test at 1316° C. for 215 hours. Upon cooling, the SiO₂ TGO layer underwent a large volume reduction during its cubic to tetragonal phase transformation, resulting in severe TGO microcracking, loss of oxidation protection properties, and premature spallation of the EBCs.

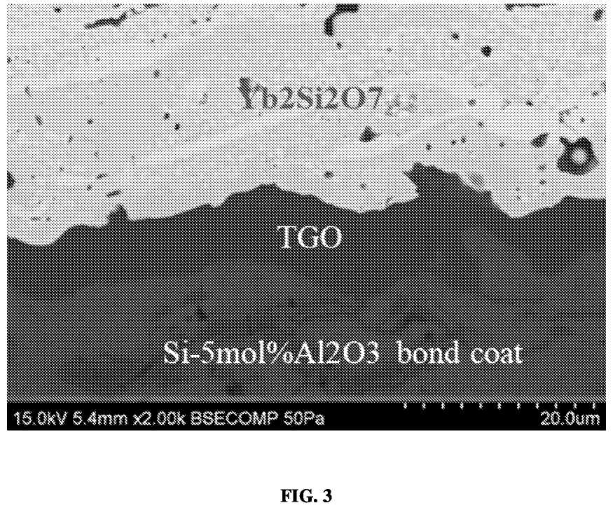

FIG. 3 illustrates a SEM image of an EBC microstructure having a Yb₂Si₂O₇ protective top layer, a bond coat including Si-5 mol % Al₂O₃, and a TGO layer, according to an example of the present disclosure. In FIG. 3, the EBC microstructure shows improved EBC durability as evidenced by no crack formations in the TGO layer or at the interface of the topcoat layer and the TGO layer after conducting a steam test at 1316° C. for 215 hours.

The Si-oxide powders can be manufactured by blend, agglomeration, plasma densification, and fused and crushed processes. The Si-oxide bond coatings may be deposited by Air Plasma Spray (APS), High Velocity Oxy-Fuel (HVOF), Low Pressure Plasma Spray (LPPS), Plasma Spray-Physical Vapor Deposition (PS-PVD), Chemical Vapor Deposition (CVD), Physical Vapor Deposition (PVD), Electron Beam-Physical Vapor Deposition (EB-PVD), Suspension/Solution Plasma Spray (SPS), Suspension/Solution HVOF (S-HVOF), and a slurry process.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A Si-based composite bond coat for environmental barrier coatings (EBCs) on a Si-based ceramic matrix composite (CMC) comprising:
a thermally grown oxide (TGO) modifier that suppresses cristobalite TGO cracking during thermal cycling in a gas turbine engine, and
at least one oxide selected from the group consisting of Al₂O₃, a combination of Al₂O₃ and an alkali metal oxide, a combination of Al₂O₃ and an alkaline earth oxide, a spinel phase AB₂O₄, and a combination of Al₂O₃ and the spinel phase AB₂O₄,
wherein A represents at least one of Mg, Ca, Ba, Sr, or Zn, and B represents at least one of Al, Fe, Cr, Co, or V.

2. The Si-based composite bond coat according to claim 1, wherein said Si-based composite bond coat comprises:
Si in a concentration range of 50 mol % to 99.9 mol %.

3. The Si-based composite bond coat according to claim 1, wherein the at least one oxide comprises mixed oxides that are obtained by mixing at least one first oxide with two valence cations and at least a second oxide with three valence cations.

4. The Si-based composite bond coat according to claim 3, wherein the Si-based composite bond coat is a Si—CaO—Al₂O₃ composite having a ratio of CaO/Al₂O₃ in a range of 0.1-1, and wherein the mixed oxides in the Si—CaO—Al₂O₃ composite are in a range of 1 mol % to 10 mol %.

5. The Si-based composite bond coat according to claim 3, wherein the Si-based composite bond coat is a Si—SrO—Al₂O₃ composite having a ratio of SrO/Al₂O₃ in a range of 0.1-1, and wherein the mixed oxides in the Si—SrO—Al₂O₃ composite are in a range of 1 mol % to 10 mol %.

6. The Si-based composite bond coat according to claim 3, wherein the Si-based composite bond coat is a Si—BaO—Al₂O₃ composite having a ratio of BaO/Al₂O₃ in a range of 0.1-1, and wherein the mixed oxides in the Si—BaO—Al₂O₃ composite are in a range of 1 mol % to 10 mol %.

9. A Si-based composite bond coat comprising:
at least one rare earth aluminate; and
at least one oxide selected from the group consisting of Al₂O₃, a combination of Al₂O₃ and an alkali metal oxide, a combination of Al₂O₃ and an alkaline earth oxide, a spinel phase AB₂O₄, and a combination of Al₂O₃ and the spinel phase AB₂O₄,
wherein A represents at least one of Mg, Ca, Ba, Sr, or Zn, and B represents at least one of Al, Fe, Cr, Co, or V.

10. A method of preparing a Si-based composite bond coat, comprising:
combining at least one rare earth aluminate and at least one oxide selected from the group consisting of Al₂O₃, a combination of Al₂O₃ and an alkali metal oxide, a combination of Al₂O₃ and an alkaline earth oxide, a spinel phase AB₂O₄, and a combination of Al₂O₃ and the spinel phase AB₂O₄,
wherein A represents at least one of Mg, Ca, Ba, Sr, or Zn, and B represents at least one of Al, Fe, Cr, Co, or V to form a mixture.

14. The Si-based composite bond coat according to claim 8, wherein the at least one rare earth aluminate concentration is in a range of 0.01 mol % to 50 mol %.

15. The Si-based composite bond coat according to claim 8, wherein the at least one rare earth aluminate concentration is in a range of 0.1 mol % to 20 mol %.

16. The Si-based composite bond coat according to claim 8, wherein the at least one rare earth aluminate concentration is in a range of 1 mol % to 10 mol %.

17. The Si-based composite according to claim 9, wherein a combination of the at least one rare earth aluminate concentration and the at least one oxide concentration is in a range of 0.01 mol % to 50 mol %.

18. The Si-based composite according to claim 9, wherein a combination of the at least one rare earth aluminate concentration and the at least one oxide concentration is in a range of 0.1 mol % to 20 mol %.

19. The Si-based composite according to claim 9, wherein a combination of the at least one rare earth aluminate concentration and the at least one oxide concentration is in a range of 1 mol % to 10 mol %.

20. A method of applying a bond coat on a Si-based CMC, comprising:
depositing the Si-based composite bond coat of claim 1 on the Si-based CMC.

21. The method according to claim 15, wherein the depositing is performed by a chemical vapor deposition process, a physical vapor deposition process, Air Plasma Spray (APS), a slurry process, Suspension/Solution Plasma Spray (SPS), Low Pressure Plasma Spray (LPPS), High Velocity Oxy-Fuel (HVOF), or an aerosol deposition process.

22. Use of a TGO modifier to suppress cristobalite TGO during thermal cycling in a gas turbine engine, wherein said TGO modifier is a rare earth aluminate, or an oxide, wherein said oxide is at least one selected from the group consisting of Al₂O₃, a combination of Al₂O₃ and an alkali metal oxide, a combination of Al₂O₃ and an alkaline earth oxide, a spinel phase AB₂O₄, and a combination of Al₂O₃ and the spinel phase AB₂O₄,
wherein “A” represents at least one of Mg, Ca, Ba, Sr, or Zn, and “B” represents at least one of Al, Fe, Cr, Co, or V.

23. The Si-based composite bond coat according to claim 2, wherein said Si is in a concentration range of 87 mol % to 99.9 mol %.

24. The Si-based composite bond coat according to claim 2, wherein said Si is in a concentration range of 92 mol % to 96 mol %.
